(19) United States
(12) Patent Application Publication
(10) Pub. No.: US 2025/0050539 A1
(43) Pub. Date: Feb. 13, 2025

(54) SAW BLADE

(71) Applicant: Weldco Fabrication and Design, LLC, Vernal, UT (US)

(72) Inventors: Rhadd Vernon Willer, Grand Junction, CO (US); Jacob Robert Willer, Vernal, UT (US)

(21) Appl. No.: 18/800,343

(22) Filed: Aug. 12, 2024

Related U.S. Application Data
(60) Provisional application No. 63/518,728, filed on Aug. 10, 2023.

(51) Int. Cl. B28D 1/12; E01C 23/09

(52) U.S. Cl. CPC B28D 1/121; E01C 23/0926

(57) ABSTRACT

A unique design is provided that may increase the strength and performance and extend the life of a saw blade, particularly when used to cut asphalt. A saw blade may include a main body forming teeth and cutters that are secured to the teeth. The cutters may be configured to extend outwardly beyond sides of the main body to minimize wear of the main body. The cutters could be configured to extend from alternating sides of the main body to create a greater effective cutting width.

### CROSS-REFERENCE TO RELATED APPLICATIONS

This application claims the benefit of U.S. Provisional Patent Application No. 63/518,728.

### BACKGROUND

It is oftentimes necessary to cut asphalt such as to repair potholes or other road damage, to install utilities, to run fiber optic cables, etc. Because asphalt is softer than other paving materials such as concrete, a specialized saw blade is typically used. Such “asphalt saw blades” typically use a strong metal to bond small diamonds to the saw blade, or more particularly, along the sides and radial edge of teeth that extend around the circumference of the saw blade's main body.

As the saw blade passes through asphalt, the diamonds grind away the asphalt. The strong metal that bonds the diamonds to the saw blade allows the diamonds to chip rather than breaking off. This ensures that a fresh cutting edge will exist on the diamonds for a prolonged period. Eventually, the diamonds will wear completely down or break off at which point the asphalt saw blade will need to be replaced.

### BRIEF SUMMARY

The present disclosure extends to saw blades. More particularly, embodiments of the present disclosure encompass a unique design of a saw blade that can increase the strength and performance and extend the life of the saw blade, particularly when used to cut asphalt. A saw blade may include a main body forming teeth and cutters that are secured to the teeth. The cutters may be configured to extend outwardly beyond sides of the main body to minimize wear of the main body. The cutters could be configured to extend from alternating sides of the main body to create a greater effective cutting width.

In some embodiments of the present disclosure, a saw blade may include a main body having a plurality of teeth and cutters secured to the plurality of teeth. The cutters have a width that is greater than a width of the main body.

In some embodiments, the cutters may be configured to extend outwardly beyond alternating sides of the main body.

In some embodiments, at least some of the cutters may include a cutter main body, a cutter plate, and a single cutting element.

In some embodiments, at least some of the cutters may include a cutter main body, a cutter plate, and multiple cutting elements.

In some embodiments, the cutters may be centered on the teeth such that the cutters extend outwardly beyond both sides of the main body.

In some embodiments, at least some of the cutters may include a cutter main body, a cutter plate, and a single cutting element.

In some embodiments, at least some of the cutters may include a cutter main body, a cutter plate, and multiple cutting elements.

In some embodiments, the main body may include cutouts and inserts secured within the cutouts. Each insert may comprise an insert main body and wear-prevention elements extending outwardly from both sides of the insert main body.

In some embodiments, the plurality of teeth may include non-elongated teeth and elongated teeth and the cutouts extend into the elongated teeth.

In some embodiments, the elongated teeth may be positioned between sets of the non-elongated teeth.

In some embodiments, each tooth may include a base, a projection positioned rearward of the base and a recess positioned rearward of the projection. The recess of a leading tooth may extend inwardly beyond the base of a trailing tooth.

In some embodiments, the main body may include cuts that extend radially inwardly from at least some of the recesses.

In some embodiments, at least some of the cutters may include a channel formed in a rear of the cutter and the projections of the corresponding teeth insert into the channel.

In some embodiments, at least some of the teeth may include a base, a projection positioned rearward of the base and a shallow cleanout surface positioned rearward of the projection. The shallow cleanout surface of a leading tooth may extend outwardly beyond the base of a trailing tooth.

In some embodiments, the main body may include cuts that extend radially inwardly from at least some of the shallow cleanout surfaces.

In some embodiments, at least some of the cutters include a cutter main body, a cutter plate, and one or more cutting elements. The cutter plate may extend outwardly beyond one or more sides of the cutter main body.

In some embodiments of the present disclosure, a saw blade may include a main body having a plurality of teeth and cutters secured to the plurality of teeth. Each cutter may have a cutter main body, a cutter plate and one or more cutting elements. Each cutter plate may extend outwardly beyond one or both sides of the main body of the saw blade.

In some embodiments, each cutter plate may extend outwardly beyond one or both sides of the respective cutter main body.

In some embodiments, at least some of the teeth include a base, a projection positioned rearward of the base and a shallow cleanout surface positioned rearward of the projection. The shallow cleanout surface of a leading tooth may extend radially outwardly beyond the base of a trailing tooth.

In some embodiments of the present disclosure, a saw blade may include a main body having a plurality of teeth and cutters secured to the plurality of teeth. The cutters may extend beyond one or both sides of the main body.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Embodiments of the present disclosure will be described and explained with additional specificity and detail through the use of the accompanying drawings in which:

FIG. 1A illustrates a portion of a saw blade that is configured in accordance with one or more embodiments of the present disclosure;

FIG. 1B illustrates a main body of the saw blade of FIG. 1A;

FIG. 1C illustrates a cutter of the saw blade of FIG. 1A;

FIG. 2A illustrates another main body that may be used for a saw blade that is configured in accordance with one or more embodiments;

FIG. 2B illustrates an insert that may be used with the main body of FIG. 2A;

FIG. 3A illustrates a portion of a saw blade that is configured in accordance with one or more embodiments of the present disclosure;

FIG. 3B illustrates a portion of the saw blade of FIG. 3B;

FIG. 3C illustrates a cutter that may be used on a saw blade that is configured in accordance with one or more embodiments including the saw blade of FIG. 3A;

FIG. 4A provides another example of a main body that may be used for a saw blade that is configured in accordance with one or more embodiments;

FIG. 4B provides an example of a cutter that may be used on a saw blade that is configured in accordance with one or more embodiments including the saw blade of FIG. 4A; and

FIG. 4C provides an example of a cutter that may be used on a saw blade that is configured in accordance with one or more embodiments including the saw blade of FIG. 4A.

### DETAILED DESCRIPTION

In the context of this application, the term “frontward” and “rearward” are used relative to the intended rotational direction of the saw blade. A frontward component will be positioned rotationally frontward of a rearward component.

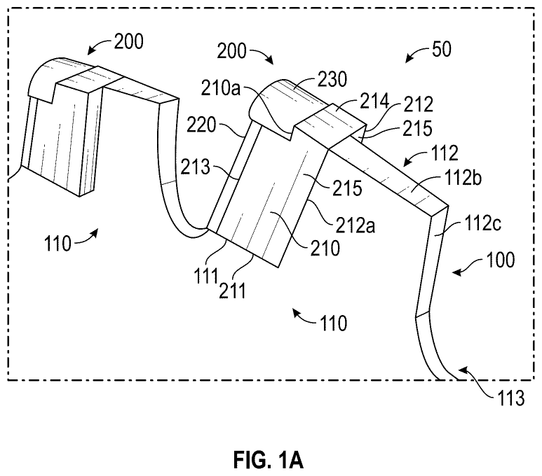

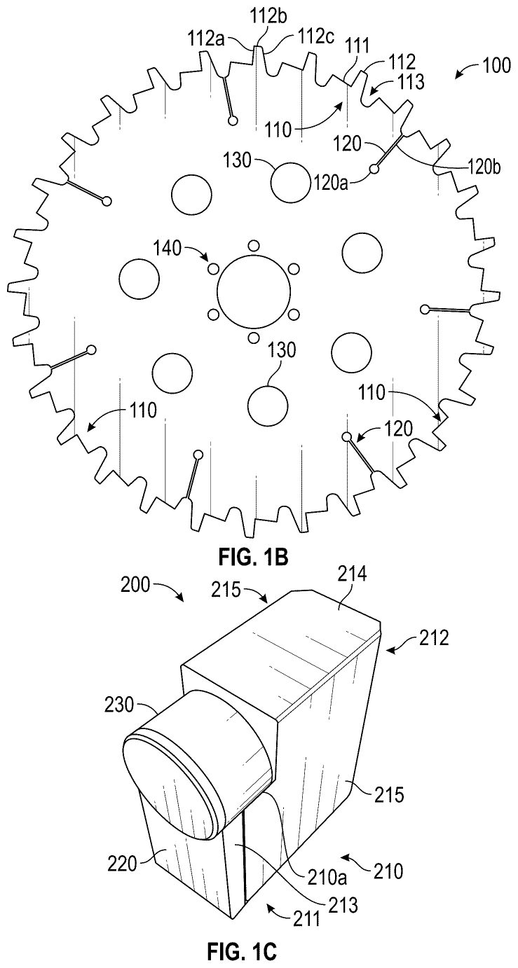

FIG. 1A is a perspective side view of a portion of a saw blade 50 that is configured in accordance with embodiments of the present disclosure. Saw blade 50, which may be an asphalt saw blade, includes a main body 100 and a number of cutters 200. More particularly, main body 100 has a circular inner shape and a number of teeth 110 that extend from a radial edge of the circular inner shape. A cutter 200 is secured to each tooth 110. FIG. 1B is a side view of main body 100 in isolation. FIG. 1C is a perspective front view of a cutter 200.

Teeth 110 are spaced around main body 100 and function as a connection point for cutters 200. Each tooth 110 includes a base 111, a projection 112 positioned rearward of base 111 and a recess 113 positioned rearward of projection 112. Base 111 can extend generally tangential to the circumference of main body 100 but may be angled slightly rearwardly (e.g., at a 7-degree rake or hook angle). Projection 112 may extend radially outward from base 111 such that a front surface 112a of projection 112 is substantially perpendicular to base 111. Projection 112 may also include an outer surface 112b that may be generally tangential to the circumference of main body 100 (e.g., at a 7-degree rake or hook angle) and a rear surface 112c that may be angled rearwardly relative to front surface 112a. Rear surface 112c may extend radially inward beyond the base 111 of the trailing tooth 110 to form recess 113. Recess 113 can function to facilitate cleaning out asphalt or other material that is being cut.

Main body 100 may also include cuts 120 that extend inwardly from at least some of recesses 113. Each cut 120 may include a widened portion 120a (e.g., a circular hole) at its most inward point and a channel 120b that extends between widened portion 120a and recess 113. Cuts 120 may function to provide stress relief to saw blade 50. Main body 100 may also include holes 130 for reducing the weight of main body 100 and mounting holes 140 for mounting saw blade 50 to the saw. Mounting holes 140 as shown are only one example and any configuration of mounting holes 140 could be employed to enable saw blade 50 to be used with any saw.

As best shown in FIG. 1C, cutter 200 includes a cutter main body 210 having a bottom 211, a rear 212, a front 213, a top 214, and opposing sides 215. Cutter main body 210 also includes a notch 210a formed in front 213 and top 214.

Cutter 200 further includes a cutter plate 220 and a single cutting element 230. In some embodiments, cutter plate 220 could be formed of carbide and cutting element 230 could be formed of polycrystalline diamond (PDC). Cutter plate 220 can be secured against front 213 and can be shaped to correspond with notch 210a. Cutting element 230 can have a cylindrical shape and can be sized to fit in notch 210a. In some embodiments, a depth of cutting element 230 (i.e., its dimension from front to rear) can be greater than the combined depth of notch 210a and cutter plate 220 such that cutting element 230 extends frontward beyond cutter plate 220.

Cutter plate 220 and cutting element 230 can be coupled to cutter main body 210 in any suitable manner (e.g., via welding). Edges of cutter main body 210 and/or tooth 110 can be chamfered to facilitate welding. Cutting elements 230 function to cut through asphalt. Cutter plates 220 function to protect cutter main body 210 and main body 100 to minimize wear.

As shown in FIG. 1A, the width of cutters 200 can be greater than the width of main body 100. In some embodiments, including the embodiment depicted in FIG. 1A, cutters 200 can be staggered. For example, cutters 200 can be secured to teeth 110 to extend from alternating sides of main body 100. This alternating of cutters 200 can cause saw blade 50 to have a greater cutting width than the width of cutters 200. For example, the width of main body 100 could be 0.5 inches and the width of cutters 200 could be 0.75 inches such that each cutter 200 extends 0.25 inches outwardly beyond the side of main body 100. By alternating to which side cutters 200 extend, the cutting width of saw blade 50 will be 1.0 inches. This same technique can be used when main body 100 and cutters 200 have different dimensions. In other embodiments, all cutters 200 could be centered on main body 100 (e.g., to create a cutting width of 0.75 inches using the same example as above).

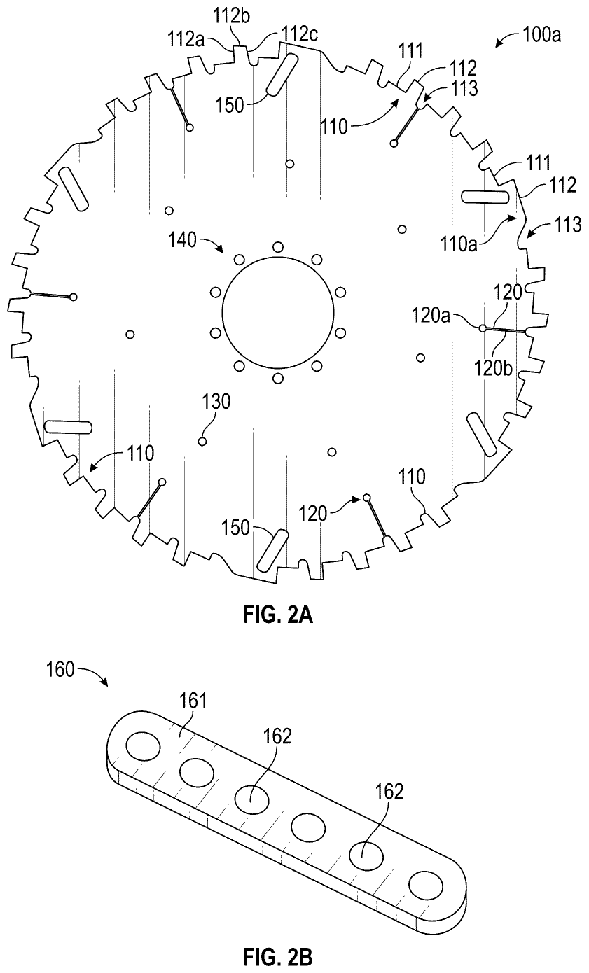

FIG. 2A provides an example of a different main body 100a that could be used for saw blade 50. Main body 100a includes teeth 110 as described above. However, main body 100a also includes elongated teeth 110a that are positioned between sets of teeth 110. In the depicted example, an elongated tooth 110a is positioned between sets of four teeth 110 but other configurations could be used. Elongated teeth 110a are generally the same as teeth 110 except that, in elongated teeth 110a, outer surface 112b is elongated and rear surface 112c has a reduced (or less sloped) angle.

Elongated teeth 110a may function to accommodate cutouts 150. Each cutout 150 may extend radially outwardly and rearwardly into an elongated tooth 110a. An insert 160, which is shown in FIG. 2B, can be secured within each cutout 150. Insert 160 includes an insert main body 161 having a shape that corresponds with cutout 150. A width of insert main body 161 may also correspond with the width of main body 100a. Edges of insert main body 161 and cutout 150 may be chamfered to enhance welding.

Insert 160 also includes a number of wear-prevention elements 162 that extend outwardly from both sides of insert main body 161. Accordingly, wear-prevention elements 162 extend outwardly beyond the sides of main body 100a to minimize wear of main body 100a. In some embodiments, wear-prevention elements 162 may be formed of polycrystalline diamond (PDC).

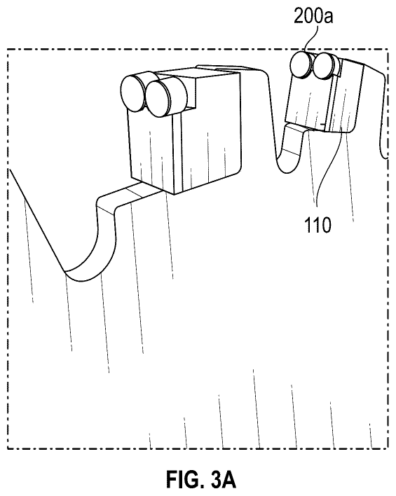

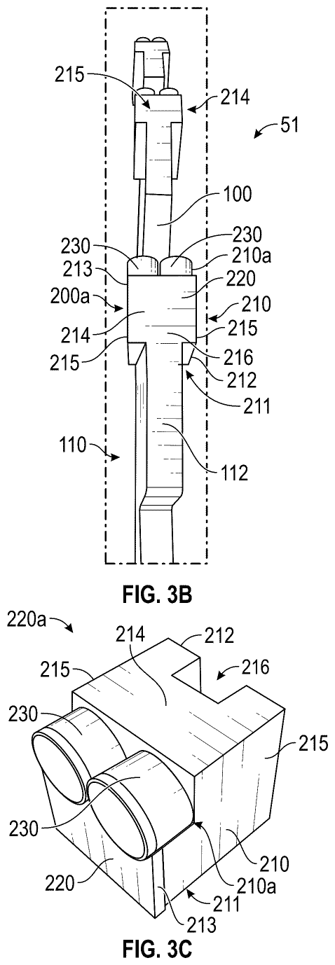

FIGS. 3A and 3B illustrate another saw blade 51 that is configured in accordance with embodiments of the present disclosure. Saw blade 51, like saw blade 50, includes main body 100 having teeth 110. However, saw blade 51 employs a cutter 200a having a slightly different configuration from cutter 200. FIG. 3C shows cutter 200a in isolation.

Cutter 200a includes a cutter main body 210 having a bottom 211, a rear 212, a front 213, a top 214, and opposing sides 215. Cutter main body 210 also includes a notch 210a formed in front 213 and top 214 and a channel 216 formed in rear 212. Channel 216 may be shaped and sized to receive projection 112 such that protrusion extends into channel 216 when cutter 200a is secured to tooth 110. Cutter 200a also includes cutter plate 220 and two cutting elements 230.

As best seen in FIG. 3B, the width of cutter 200a is greater than the width of main body 100 such that a portion of cutter 200a extends outwardly beyond both sides of main body 100. For example, the width of cutter 200a could be 1.5 inches to create a cutting width of 1.5 inches. However, other dimensions could be used.

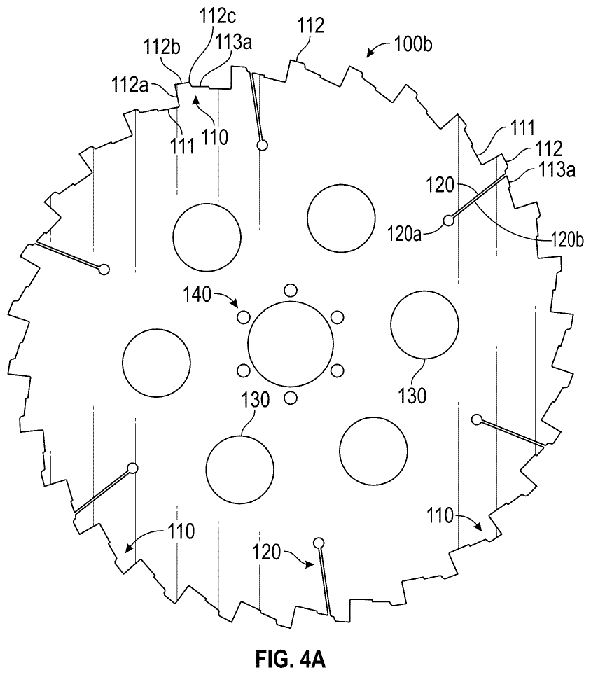

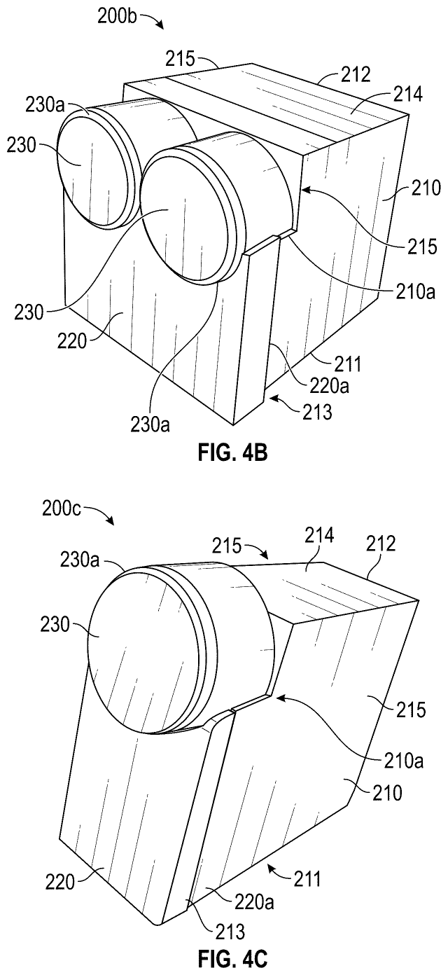

FIG. 4A provides another example of a main body 100b that could be used for saw blade 50. Main body 100b includes teeth 110 similar to those described above except that the teeth do not include recess 113. Instead, teeth 110 (or at least some of teeth 110) include a shallow cleanout surface 113a that extends between rear surface 112c and the trailing base 111. In some embodiments, including the depicted embodiments, shallow cleanout surface 113a may be positioned radially outward from base 111. In some embodiments, base 111, outer surface 112b and/or shallow cleanout surface 113a could be oriented at a rake angle between 12-14 degrees or 13 degrees. In some embodiments, main body 100b may include larger holes 130 for reducing weight (e.g., 6 holes having a diameter of 5 inches). In some embodiments, main body 100b does not include cutouts 150.

In some embodiments, cutters 200 and/or 200a as described above could be used with main body 100b. In other embodiments, cutters 200b and/or 200c as shown in FIGS. 4B and 4C could be used.

Cutter 200b in FIG. 4B is generally the same as cutter 200a in FIG. 3C except that cutter 200b does not include channel 216. Instead, rear 212 of cutter main body 210 in cutter 200b can be positioned against front surface 112a of projection 112. In some embodiments, including the depicted embodiments, cutter plate 220 may have a width that is greater than the width of cutter main body 210 such that a portion 220a of cutter plate 220 extends beyond one or both of opposing sides 215. In some embodiments, portion 220a can provide protection to main body 100b (or another embodiment of the main body) in a similar manner as inserts 160. In some embodiments, each cutting element 230 may have a chamfered leading edge 230a.

Cutter 200c in FIG. 4C is generally the same as cutter 200 in FIG. 1C except that cutter 200c includes portion 220a and chamfered leading edge 230a as described above. Also, in cutter 200c, rear 212 of cutter main body 210 does not include chamfered edges.

On both cutter 200b and cutter 200c, the thickness of cutter plate 220 is increased and may be approximately 0.25 inches.

A saw blade configured in accordance with embodiments of the present disclosure can minimize wear on the main body and thereby prolong the life of the saw blade. For example, by configuring the cutters to extend outwardly beyond the sides of the main body, the main body will make less contact with the asphalt (or other material) during cutting. Similarly, by employing inserts and/or by extending the width of the cutter plates, the inevitable contact along the sides of the main body can be distributed against the wear-prevention elements rather than the main body itself.

Although each described and depicted embodiment includes different combinations of features, any reasonable combination of the described or depicted features could be used on a saw blade configured in accordance with the present disclosure.

What is claimed:

1. A saw blade comprising:
a main body having a plurality of teeth; and
cutters secured to the plurality of teeth, wherein the cutters have a width that is greater than a width of the main body.

2. The saw blade of claim 1, wherein the cutters are configured to extend outwardly beyond alternating sides of the main body.

3. The saw blade of claim 2, wherein at least some of the cutters include a cutter main body, a cutter plate, and a single cutting element.

4. The saw blade of claim 2, wherein at least some of the cutters include a cutter main body, a cutter plate, and multiple cutting elements.

5. The saw blade of claim 1, wherein the cutters are centered on the teeth such that the cutters extend outwardly beyond both sides of the main body.

6. The saw blade of claim 5, wherein at least some of the cutters include a cutter main body, a cutter plate, and a single cutting element.

7. The saw blade of claim 5, wherein at least some of the cutters include a cutter main body, a cutter plate, and multiple cutting elements.

8. The saw blade of claim 1, wherein the main body includes cutouts and inserts secured within the cutouts, each insert comprising an insert main body and wear-prevention elements extending outwardly from both sides of the insert main body.

9. The saw blade of claim 8, wherein the plurality of teeth include non-elongated teeth and elongated teeth and the cutouts extend into the elongated teeth.

10. The saw blade of claim 9, wherein the elongated teeth are positioned between sets of the non-elongated teeth.

11. The saw blade of claim 1, wherein at least some of the teeth include a base, a projection positioned rearward of the base and a recess positioned rearward of the projection, and wherein the recess of a leading tooth extends inwardly beyond the base of a trailing tooth.

12. The saw blade of claim 11, wherein the main body includes cuts that extend radially inwardly from at least some of the recesses.

13. The saw blade of claim 11, wherein at least some of the cutters include a channel formed in a rear of the cutter and the projections of the corresponding teeth insert into the channel.

14. The saw blade of claim 1, wherein at least some of the teeth include a base, a projection positioned rearward of the base and a shallow cleanout surface positioned rearward of the projection, and wherein the shallow cleanout surface of a leading tooth extends outwardly beyond the base of a trailing tooth.

15. The saw blade of claim 14, wherein the main body includes cuts that extend radially inwardly from at least some of the shallow cleanout surfaces.

16. The saw blade of claim 1, wherein at least some of the cutters include a cutter main body, a cutter plate, and one or more cutting elements, and wherein the cutter plate extends outwardly beyond one or more sides of the cutter main body.

17. A saw blade comprising:
a main body having a plurality of teeth; and
cutters secured to the plurality of teeth, each cutter having a cutter main body, a cutter plate and one or more cutting elements, and wherein each cutter plate extends outwardly beyond one or both sides of the main body of the saw blade.

18. The saw blade of claim 17, wherein each cutter plate extends outwardly beyond one or both sides of the respective cutter main body.

19. The saw blade of claim 17, wherein at least some of the teeth include a base, a projection positioned rearward of the base and a shallow cleanout surface positioned rearward of the projection, and wherein the shallow cleanout surface of a leading tooth extends radially outwardly beyond the base of a trailing tooth.

20. A saw blade comprising:
a main body having a plurality of teeth; and
cutters secured to the plurality of teeth, wherein the cutters extend beyond one or both sides of the main body.
